(19) United States
(12) Patent Application Publication
(10) Pub. No.: US 2012/0222534 A1
(43) Pub. Date: Sep. 6, 2012

(54) BEVEL ADJUSTMENT FOR A PUSH-PULL TABLE SAW

(75) Inventor: Venu Samprathi, Mt. Prospect, IL (US)

(73) Assignees: ROBERT BOSCH GMBH, Stuttgart (DE); ROBERT BOSCH TOOL CORPORATION, Palatine, IL (US)

(21) Appl. No.: 13/039,420

(22) Filed: Mar. 3, 2011

(51) Int. Cl. B27B 5/20; B26D 3/02; B23D 45/06

(52) U.S. Cl. 83/471.3

(57) ABSTRACT

A push-pull power tool. The push-pull power tool includes a table, a carriage configured to move along the table in a linear direction, a cutting assembly carried by the carriage, and a bevel adjustment arrangement configured to pivot the cutting assembly relative to the table, the bevel adjustment arrangement including an actuator, wherein the actuator is configured to remain substantially stationary in the linear direction when the carriage is moved a substantial distance in the linear direction.

### FIELD

The invention relates to a bench-type power tool, and in particular to a push-pull power tool.

### BACKGROUND

Bench-top power tools come in a variety of different designs. In most cases, a bench-top power tool includes a frame or a housing which includes a top portion for supporting a workpiece (e.g., a piece of wood) and a shaping tool (e.g., a saw assembly) with a blade. The shaping tool is positioned above the top portion for shaping the workpiece (e.g., cutting the workpiece). The shaping tool is generally supported by a support member (e.g., a carriage).

Bench-top power tools may be divided into two categories. In a first category the shaping tool is not moveable (i.e., stationary) along an axial direction parallel to a length of the frame. An operator of the power tool moves the workpiece toward the shaping tool in order to shape the workpiece. In a second category, the shaping tool is moveable and the operator moves the shaping tool toward the workpiece. The support member, in the second category, is generally coupled to sliding members (e.g., tracks) to move the support member relative to the top portion.

Bench-type power tools with moveable shaping tools provide certain advantages. For example, the operator may fix the workpiece to the top portion with fixing members (e.g., clamps) which may result in an easier shaping operation in cases where the workpiece is large (e.g., a sheet of plywood). The operator can grasp a gripping member (e.g., a knob) that is connected to a rod that is coupled to the shaping tool and slide the shaping tool forward toward a front portion of the power tool, in order to shape the workpiece.

Most bench-top power tools are also designed to provide adjustability of the shaping tool with respect to the top portion, which in turn provides adjustability with respect to the workpiece. For example, the shaping tool may be adjustable to provide a bevel shaping angle. The adjustments are performed by adjustment controls (e.g., knobs or levers). The operator may desire to adjust the bevel angle of the shaping tool to a predetermined angle, or alternatively, adjust the bevel angle by visually inspecting the bevel angle of the shaping tool with respect to the workpiece.

The adjustment controls of the push-pull saws of the prior art are coupled to the shaping tool and slide with the shaping tool with respect to the top portion and the frame or the housing. As a result, the controls may be unreachable by the operator when the shaping tool is in a position that is far from the operator.

In the case where the operator desires to adjust the bevel angle to a predetermined angle, the bevel angle adjustment control may be completely under the bench when the shaping tool is remote from the operator. In such a situation the operator may inconveniently need to reach under the bench and make the desired adjustments. Alternatively, the operator may need to slide the shaping tool so that the adjustment controls are reachable. In either case, the operator may be inconvenienced.

In the case where the operator desires to visually change the bevel angle of the shaping tool with respect to the workpiece, the operator may be excessively inconvenienced. In this situation, the operator may be required to follow a cumbersome procedure. In particular, the operator may be required to push the shaping tool toward the back portion of the bench, place the workpiece on the top portion, and inspect the bevel angle of the blade with respect to the workpiece. If the angle is incorrect, the operator may be required to remove the workpiece, slide the shaping tool toward the front portion of the bench in order to be able to reach the bevel angle control, adjust the angle, and repeat the aforementioned angle-adjustment procedure.

Therefore, while adjusting the bevel angle of the shaping tool with the workpiece remaining on the top portion of the bench may be possible by the operator reaching the bevel angle control that may be located under the bench, such an adjustment is inconvenient for the operator. Therefore, there is a need to be able to adjust the bevel angle of a bench-type push-pull shaping tool in a convenient manner.

### SUMMARY

According to one embodiment of the present disclosure, there is provided a push-pull power tool. The push-pull power tool includes a table, a carriage configured to move along the table in a linear direction, a cutting assembly carried by the carriage, and a bevel adjustment arrangement configured to pivot the cutting assembly relative to the table, the bevel adjustment arrangement including an actuator, wherein the actuator is configured to remain substantially stationary in the linear direction when the carriage is moved a substantial distance in the linear direction

According to another embodiment of the present disclosure, there is provided a push-pull table saw. The push-pull table saw includes a table, a carriage configured to move along the table in a linear direction, a cutting assembly carried by the carriage, and a bevel adjustment arrangement configured to pivot the cutting assembly relative to the table, the bevel adjustment arrangement including an actuator, wherein the actuator is configured to remain substantially stationary in the linear direction when the carriage is moved a substantial distance in the linear direction, and a height control member coupled to the saw assembly and configured to move the blade parallel to a second axis along the height of the housing in response to movement of the height control member, wherein the bevel control member remains vertically stationary during movement of the blade parallel to the second axis

According to yet another embodiment of the present disclosure, there is provided a push-pull saw. The push-pull saw includes a carriage configured to movably support a saw assembly, a push-pull rod coupled to the carriage and operable to move the carriage in a linear path of movement in response to the push-pull rod being moved in the linear path, and a bevel control rod coupled to the carriage and operable to move the saw assembly in a bevel path defined within a plane substantially perpendicular to the linear path in response to rotation of the bevel control rod, wherein the bevel control rod remains axially stationary during movement of the push-pull rod and the carriage in the linear path.

### BRIEF DESCRIPTION OF THE DRAWINGS

FIG. 1 depicts a perspective view of a push-pull table saw with a top portion and with an axially fixed bevel angle adjustment knob and a height adjustment control knob;

FIG. 2 depicts a fragmentary perspective view of a carriage including a pair of sliding brackets capable of sliding on two sliding members, and a carrier configured to support a saw assembly and an accompanying blade shown above the top portion of the push-pull table saw of FIG. 1;

FIG. 3 depicts a plan view of one of the two sliding brackets shown in FIG. 2 coupled to the sliding members and to apportion of the carrier;

FIG. 3A depicts an enlarged portion of FIG. 3 showing an angular engagement between a splined shaft and a toothed arc;

FIG. 4 depicts a fragmentary perspective view of a sliding mechanism according to one embodiment of the present disclosure;

FIG. 5A depicts a simplified perspective view of the push-pull table saw of FIG. 1 with a push-pull rod coupled to the saw assembly in a first position;

FIG. 5B depicts a simplified perspective view of the push-pull table saw of FIG. 1 with the push-pull rod coupled to the saw assembly in a second position;

FIG. 6 depicts a perspective view of a push-pull table saw according to another aspect of the present disclosure including a keyed shaft, a bearing assembly, and a geared interface for providing a bevel function; and

FIG. 7 depicts a fragmentary cross sectional view of a bearing assembly of the geared interface of FIG. 6.

### DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one of ordinary skill in the art to which this invention pertains.

While a push-pull table saw is depicted in the figures of the present disclosure, it should be understood that the present disclosure applies to other types of push-pull bench-type power tools. For example, the present disclosure can also apply to a push-pull router that is coupled to a bench. Therefore, where a power saw or a saw assembly is referenced, it should be appreciated that other power tools, such as a router, may be substituted for the power saw.

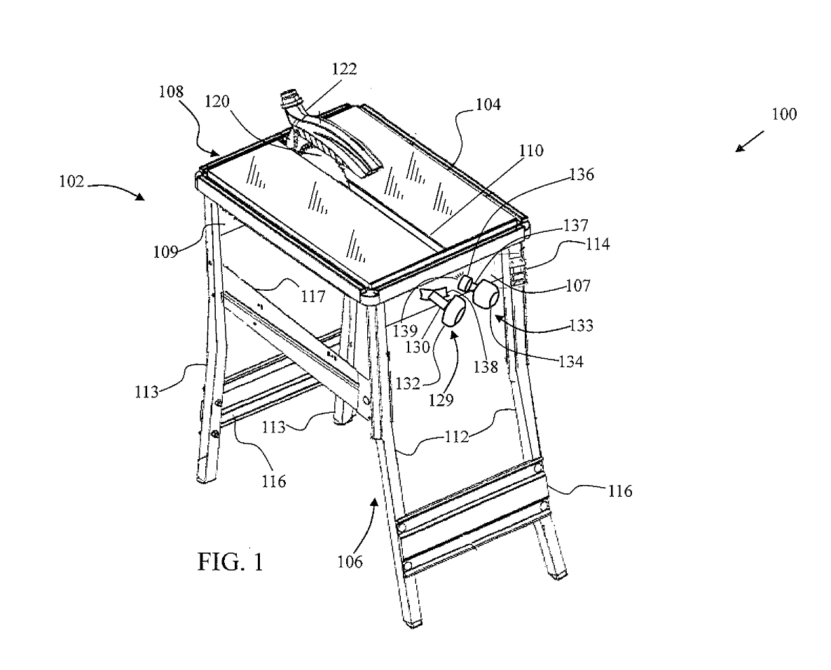

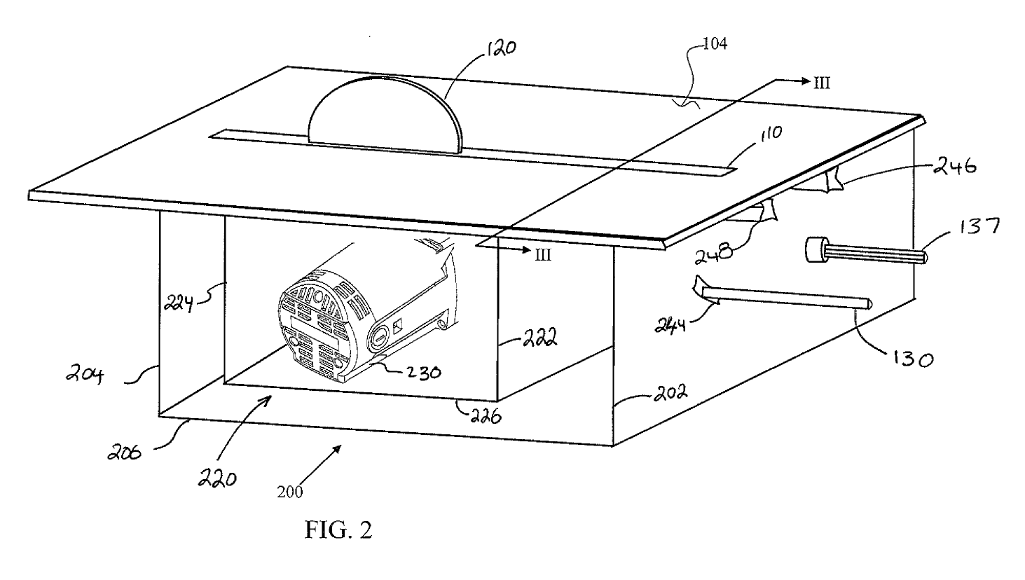

FIG. 1 depicts a push-pull table saw 100. The push-pull table saw 100 includes a table 102, a height adjustment arrangement 129 and a bevel angle adjustment arrangement 133. The push-pull saw 100 further includes a carriage 200 (FIG. 2), and sliding members in the form of tracks 246 and 248 (FIG. 2). Also, the push-pull saw 100 includes a saw assembly 230 (FIG. 2).

The table 102 includes a table top 104, a front portion 106, and a rear portion 108. The table 102 can be formed in a shape of an enclosed housing, or as shown in FIG. 1 in an open form. The table top 104 is in a shape of a rectangle and includes an elongated opening 110 formed along the length of the table top 104. The front portion 106 includes a front plate 107 and legs 112. The rear portion 108 includes a rear plate 109 and legs 113. A power switch 114 is mounted on one of the legs 112 of the front portion 106 (as depicted in FIG. 1) or may be mounted to the front plate 107. Cross brackets 116 are coupled between the legs 112 in the front portion 106 and the legs 113 in the rear portion 108. A cross bracket 117 connects legs 112 and 113 of the front and rear portions 106 and 108, respectively.

The saw assembly 230 (FIG. 2) is located under the table top 104 of the table 102. The saw assembly 230 is configured to move in a linear direction relative to the table 102 when a push-pull rod in the form of a shaft 130 is moved in the linear direction. A saw blade 120 which is coupled to the saw assembly 230 is positioned above the table top 104, as depicted in FIG. 1. The saw blade 120 extends through the opening 110 and is capable of sliding along the length of the opening 110. A riving knife assembly 122 is also depicted in FIG. 1. The riving knife assembly 122 is connected to the saw assembly 230 and is configured to move with the saw blade 120. The riving knife assembly 122 provides a riving function by a riving knife disposed behind the saw blade 120, a protective function by a blade protective cover disposed above the saw blade 120, and a vacuum function to remove debris and wood particles from the surroundings of the saw blade 120 by a vacuum hose connection disposed to the rear of the saw blade 120.

The height adjustment arrangement 129 includes the shaft 130 connected to an actuator in the form of a height adjustment control knob 132. The shaft 130 extends through an arcuate opening 138 formed in the front portion 106 on the front plate 107.

The height adjustment control knob 132 is connected to the shaft 130 and provides a push-pull function as well as a rotational function. Therefore, linear movement of the height adjustment control knob 132 from a position near the front plate 107 to a position remote from the table 102, results in a linear movement of the saw assembly 230 along a linear path from a position near the back portion 108 to a position near the front portion 106, respectively. As a result, linear movement of the height adjustment control knob 132 results in a linear movement of the blade 120 from a position near the back portion of the opening 110 to a position near the front portion of the opening 110.

In addition to linear movement of the height adjustment control knob 132, the knob 132 can also be rotated. The shaft 130 is coupled to the saw assembly 230 (FIG. 2). The blade 120 is operated by the saw assembly 230 for cutting the workpiece. Rotating the height adjustment control knob 132 turns the shaft 130. Rotation of the shaft 130, as will be explained in greater detail below, results in adjusting height of the blade 120 extending above the table top 104.

The bevel angle adjustment arrangement 133 includes a bevel angle adjustment knob 134 connected to a bevel control rod 137 and which extends through an optional bushing 136 affixed to the front plate 107. The bevel control rod 137 is a rod that can be fully or partially formed in the form of a splined shaft. The bushing 136 may be configured to provide a rotational locking feature for the splined shaft 137 utilizing a ratchet and a pawl arrangement known to one of ordinary skill in the art. The bevel control rod 137 extends the length of the table 102 to an optional complementary bushing (not shown) on the rear plate 109.

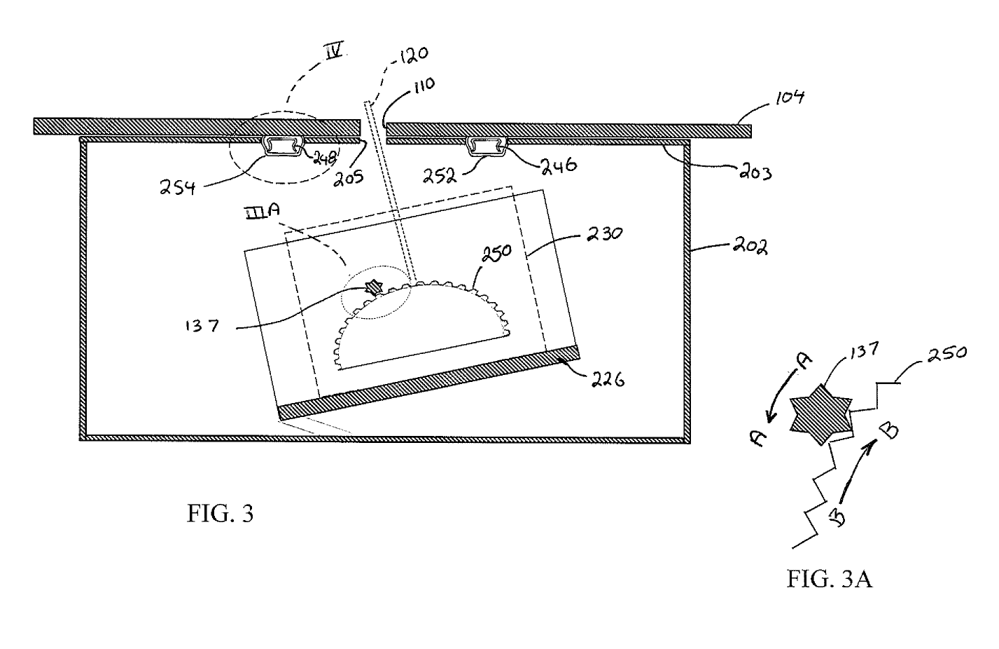

The bevel angle adjustment knob 134 is axially fixed with respect to the front plate 107, i.e., the bevel angle adjustment knob 134 does not move along a linear path parallel to the length of the table 102. However, the bevel angle adjustment knob 134 is rotationally moveable. As will be described in greater detail below, rotating the bevel angle adjustment knob 134 causes rotation of the bevel control rod 137 which causes rotation of the saw assembly 230 with respect to the table top 104 which provides a desired bevel angle for the blade 120. Therefore, the bevel control rod 137 that is coupled to a pivotable mount in the form of a carrier 220, to which the saw assembly 230 is mounted (FIG. 3), is operable to rotate the carrier 220 and with it the saw assembly 230 and the blade 120 in a bevel path defined within a plane that is substantially perpendicular to the linear path of the blade 120.

Since the shaft 130 and the height adjustment control knob 132 are coupled to the saw assembly 230, rotating the bevel angle adjustment knob 134 also causes movement of the height adjustment control knob 132 and the shaft 130 along an arcuate path with respect to the front plate 107 and defined by the arcuate opening 138. The arcuate opening 138 is, therefore, provided on the front plate 107 to provide sufficient space for the shaft 130 to move in response to rotation of the bevel angle adjustment knob 134.

FIG. 2 depicts the carriage 200. The carriage 200 includes sliding brackets 202 and 204 that are coupled to the sliding members 246 and 248. The sliding members 246 and 248 may be extended along the entire length of the table 102, and be connected to the front and rear plates 107 and 109. Alternatively, the sliding members 246 and 248 may be extended partially along the length of the table 102 and be connected to the underside of the table top 104. The sliding brackets 202 and 204 are connected to each other by a bottom plate 206.

The carriage 200 also includes a pivotable mount in a form of the carrier 220. The carrier includes side walls 222 and 224 and a bottom plate 226 for connecting the side walls 222 and 224 and for supporting the saw assembly 230 which is connected to the bottom plate 226.

A portion of the shaft 130 is shown in FIG. 2. The shaft 130 extends through an arcuate opening 244 formed in the sliding bracket 202. Also shown in FIG. 2 is a portion of the bevel control rod 137. The bevel control rod 137 is optionally coupled to a bushing 242 mounted on the sliding bracket 202. As described above, the bevel control rod 137 includes splines that fully or partially extend the length of the bevel control rod 137. Splines of the bevel control rod 137 engage toothed arcs in the form of gear teeth 250 (FIG. 3) which are mounted to the side walls 222 and 224, discussed in greater detail below.

FIG. 3 depicts a partial cross sectional view of a section of the push-pull table saw 100 about a line identified as III-III in FIG. 2. Depicted in FIG. 3 is the sliding bracket 202. Also depicted in FIG. 3 are the side wall 222 and the bottom plate 226 of the carrier 220. While only one sliding bracket (202) and one side bracket (222) are depicted in FIG. 3, it should be understood that a similar arrangement exists for the sliding bracket 204 and the side wall 224. As described above, and more clearly depicted in FIG. 3, the saw assembly 230 is supported by the bottom plate 226. The blade 120 extends through the opening 110 and through a corresponding opening 205 formed in the top plate 205. The gear teeth 250 are formed on the side wall 222 and interface with splines of the bevel control rod 137. The gear teeth 250 can be integrally formed with the side wall 222 or alternatively mounted onto the side wall 222.

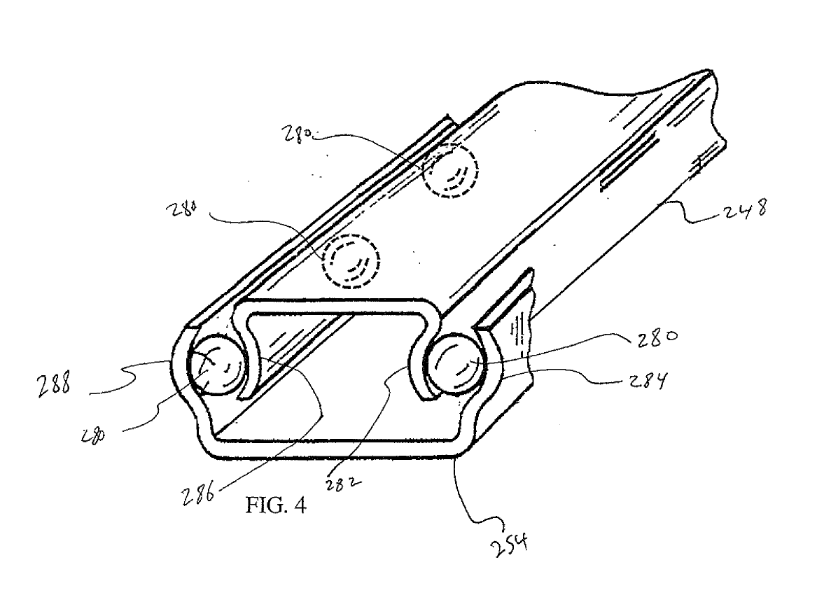

The sliding bracket 202 slidably interfaces with the sliding members 246 and 248 by complementary sliding members 252 and 254, respectively. The sliding interfaces 246/252 and 248/254 are further described below in reference to FIG. 4.

Since the side wall 222 and the bottom plate 226 are connected, rotating the bevel angle adjustment knob 134 causes rotation of the bevel control rod 137 which causes rotation of the side wall 222 which causes rotation of the bottom plate 226. Rotation of the bottom plate causes rotation of the saw assembly 230 which causes beveling of the saw blade 120. The ends of the arcuate opening 244 may be used to provide limits for how far the carrier 220 can rotate.

While the splined interface between the gears 250 and the splines of bevel control rod 137 provide the rotational movement for the carrier 220, the same splined interface can also provide a sliding interface. Once the desired rotational position has been reached (i.e., the bevel angle), the carriage 200 can be slidably moved from the position near the rear portion 108 to the position near the front portion 106, and vice versa. The complementary sliding members 246/252 and 248/254 provide the axial sliding interface of the sliding bracket 202 with respect to the table top 104. FIG. 3A depicts an enlarged portion of FIG. 3, encircled and indentified as IIIA, which depicts the interface between the splined shaft 137 and the toothed arc with gear teeth 250. Rotation of the splined shaft 137 in a direction identified as AA causes movement of the toothed arc in a direction identified as BB.

FIG. 4 depicts a fragmentary perspective view of complementary sliding interfaces 248/254 encircled in FIG. 3 and identified as IV. It should be understood that a similar sliding interface also exists for the sliding members 246/252. Also, a set of complementary sliding interfaces 248/254 and 246/252 exist for the sliding bracket 204. As described above, the sliding member 248 may be configured to extend substantially the length of the table 102. The complementary sliding member 254, however, is a short member connected to the sliding bracket 204. The sliding member 254 includes ball bearings 280 which are encapsulated in partial cavities formed by flare-outs 284 and 288. The ball bearings 280 also interface with partial cavities formed on the sliding member 248 by flare-ins 282 and 286.

As explained above, the shaft 130 is utilized to both slide the carriage 200 along the length of the table 102 as well as to adjust the height of the blade 120 with respect to the table top 104. The shaft 130 is coupled to the saw assembly 230. While pulling and pushing of the shaft 130 forces the saw assembly 230 and consequently the carriage 200 to slide, rotating the shaft 130 causes the blade 120 to raise and lower with respect to the table top 104. However, only the blade 120 moves up and down and not the saw assembly 230. In other words, the carrier 220 and the carriage 200 are stationary in the vertical direction.

In operation, the operator of the push-pull table saw 100 can push the height adjustment control knob 132 to move the carriage 200 including the carrier 220 to the position near the rear portion 108. The operator can then place a workpiece on the table top 104 and position the workpiece next to the blade 120. The operator can adjust the bevel angle of the blade 120 by rotating the bevel angle adjustment knob 134 and bevel control rod 137 by releasing the optional pawl from a splined portion of the bevel control rod 137. Regardless of the position of the carriage 200, the bevel angle adjustment knob 134 is advantageously disposed at the front portion of the push-pull table saw 110. Rotation of the bevel control rod 137 causes rotation of the carrier 220 with respect to the surface of the table top 104 which causes beveling of the saw blade 120 with respect to the table top 104. Once the desired bevel angel has been reached, the operator can turn on the saw assembly 230 by activating the power switch 114, and pulling the carriage 200 to the position near the front portion 106 in order to cut the workpiece at the desired bevel angle. Similarly, the operator can adjust the bevel angle of the blade 120 when the carriage 200 is at the position near the front portion of the push-pull saw 100.

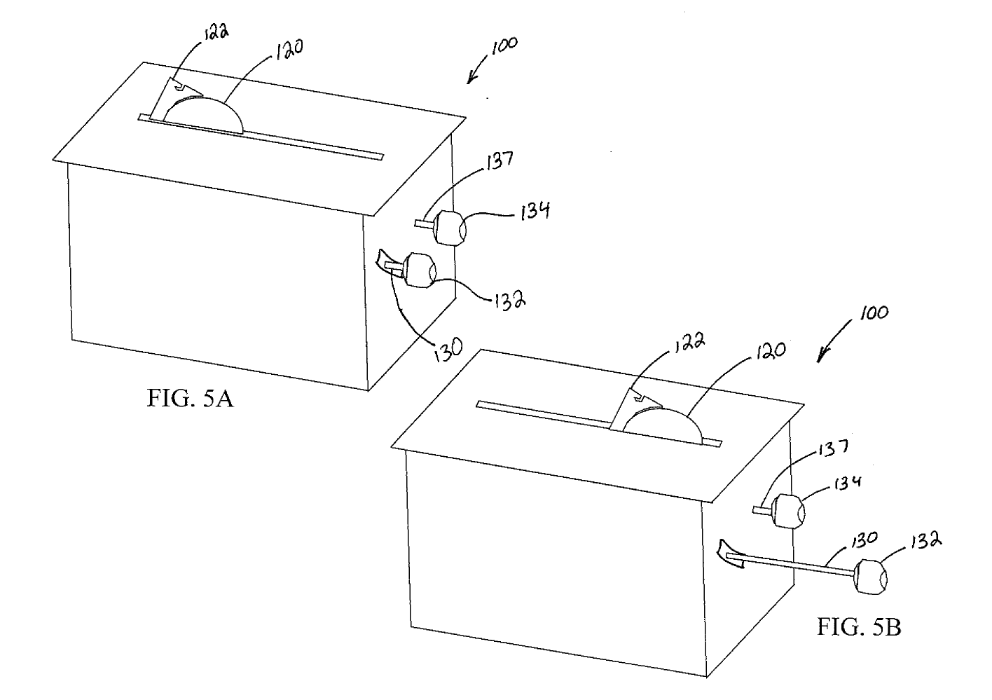

FIG. 5A depicts a simplified perspective view of the push-pull table saw 100 of FIG. 1, in a first position. The saw blade 120 and the riving knife assembly 122 are slidably provided in the elongated opening 110 and the two are coupled to a carriage (not shown) which is also coupled to the shaft 130 and to the height adjustment control knob 132. As depicted in FIG. 5A, in the first position, the saw blade 120 and the riving knife assembly 122 are pushed back to a rearward end of the elongated opening 110 in response to the height adjustment control knob 132 being completely pushed inwardly. The bevel angle adjustment knob 134 is positioned in a first position as depicted in FIG. 5A.

FIG. 5B depicts the simplified perspective view of the push-pull table saw 100 of FIG. 5A in a second position. In the second position, the saw blade 120 and the riving knife assembly 122 are pulled forward to the opposite end of the elongated opening 110 as compared to FIG. 5A in response to the height adjustment control knob 132 being completely pulled outwardly. The bevel angle adjustment knob 134, however, remains in the same position as that depicted in FIG. 5A.

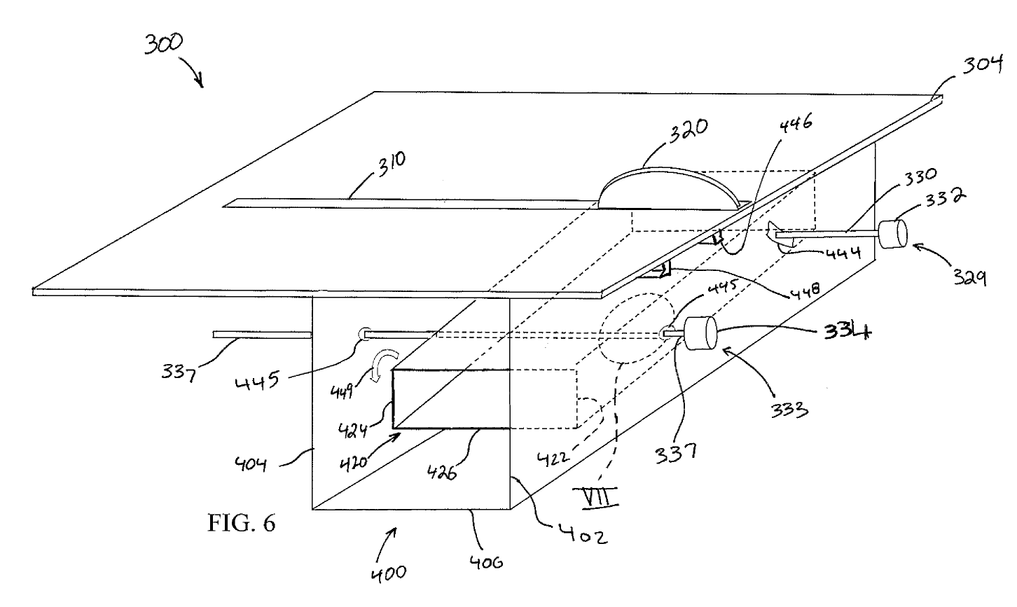

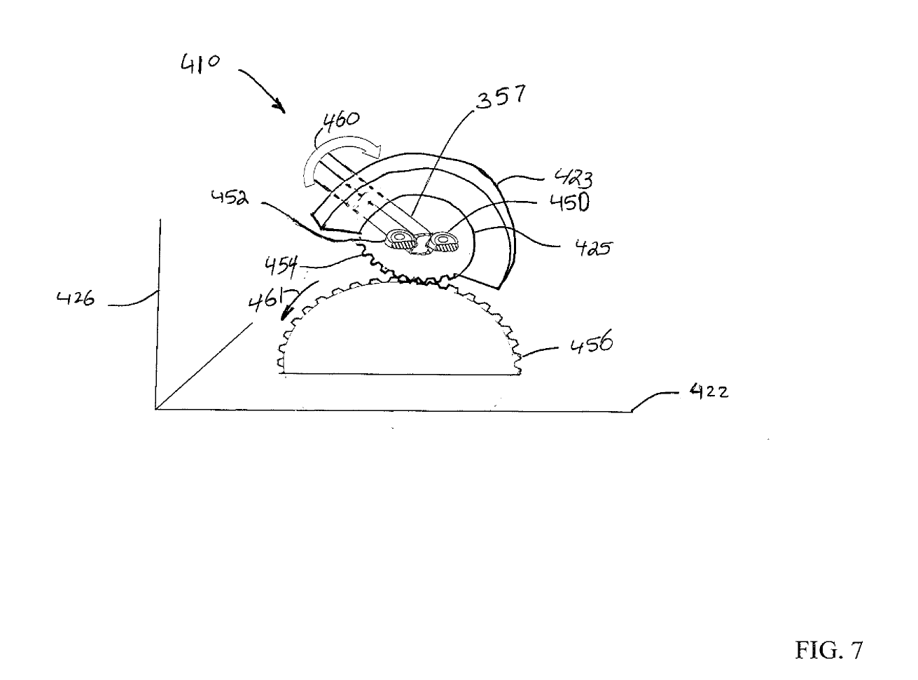

While the embodiment of the push-pull table saw 100 described above uses a bevel control rod 137 that is partially or fully splined, another embodiment of a push-pull saw is described below. FIG. 6 depicts a perspective view of another embodiment of a push-pull table saw 300. For added clarity, only internal structures of the push-pull table saw 300 are depicted. Therefore, while the push pull table saw 300 may include a table (not shown) similar to the table 102 depicted in FIG. 1 or a housing (not shown) that is formed around the internal structures, these outside structures are not shown for added clarity. The push-pull table saw 300 includes a table top 304 with an elongated opening 310 formed thereon, a bevel adjustment mechanism 333 and a height adjustment-push pull mechanism 329. A blade 320 attached to a saw assembly (not shown) extends through the elongated opening 310. The blade 320 is depicted in a beveled angle with respect to the table top 304. The bevel adjustment mechanism includes a knob 333 and a keyed shaft 337 attached thereto (more clearly depicted in FIG. 7). The height adjustment-push pull mechanism 329 also includes a knob 332 and a rod 330. Included in the table saw 300 is also a carriage 400 and a pivotable mount in the form of a carrier 420.

The carriage 400 includes sidewalls 402 and 404 and an optional bottom member 406. An arcuate opening 444 is formed in the side wall 402 of the carriage 400 allowing for passage of the rod 330 and for arcuate movement of the rod 330. Similarly, opening 445 are formed in the side walls 402 and 404 allowing for passage of the keyed shaft 337. The keyed shaft 337 is coupled to the handle 334 and is configured to rotate in response to rotation of the handle 334. While the keyed shaft 337 is depicted to pass through openings 445 disposed on the side walls 402 and 404, bearing assemblies (not shown) mounted on the side walls 402 and 404 can also be provided to provide additional support for the keyed shaft 337. The keyed shaft 337 is depicted to extend beyond the carriage 400 on both sides of the carriage 400. The keyed shaft 337 can be configured to extend to the outside structures (not shown) such as the housing (not shown). Sliding members 446 and 448 are attached to the bottom side of the table top 304. The side walls 402 and 404 slidably interface with the sliding members 446 and 448 by complementary sliding members (not shown), similar to the sliding interfaces 246/252 and 248/254 depicted in FIG. 4.

While the rod 330 is allowed to move with respect to the carriage 400 about an arcuate path defined by the arcuate opening 444, the rod 330 is axially fixed with respect to the carriage. Therefore, pulling and pushing of the knob 332 causes the carriage 400 to slidably engage with the sliding members 446 and 448 and thereby cause the carriage to move from left to right and vice versa with respect to FIG. 6.

The push-pull table saw 300 also includes a carrier 420 for supporting the saw assembly (not shown). The carrier 420 is positioned within the carriage 400 and is axially fixed with respect to the carriage 400. The carrier 420 includes side walls 422 and 424 and a bottom support surface 426, configured to support the saw assembly (not shown). The carriage 420 includes a bearing assembly 410 (depicted in FIG. 7) for receiving the keyed shaft 337 and thereby causing tilting of the carrier 420 with respect to the carriage 400 about an arrow 449. As a result of rotation of the knob 334, the carrier 420 is depicted in a tilted position in FIG. 6 such that distal end of the carrier (i.e., the end closer to the rod 330) is positioned higher (i.e., closer to the table top 304) than the proximal end of the carrier 420 (i.e., the end closer to the keyed shaft 337).

FIG. 7 depicts a fragmentary cross sectional view of the bearing assembly 410, encircled in FIG. 6 and identified as VII. The bearing assembly 410 includes an outer portion 423 which is fixedly coupled to the side wall 422. The bearing assembly 410 also includes an inner portion 425 which rotationally interfaces with the outer portion 423. Two bearing members 450 and 452 interface with the keyed shaft 337 and thereby allow the keyed shaft 337 to slide with respect to the side wall 422, and therefore with respect to the carrier 420 and carriage 400. However, due to the configuration of the keyed shaft 337 and the bearing members 450 and 452, rotation of the keyed shaft causes a corresponding rotation of the inner portion 425.

The inner portion 425 includes gears 454 which interface with toothed arcs in the form of gears 456. Gears 456 are fixedly mounted or integrated with the side wall 422. Therefore, rotation of the keyed shaft 337, which as described above, causes rotation of the inner portion 425 of the bearing assembly 410, causes rotation of the side wall 422 which causes rotation of the carrier 420 within the carriage 400. These corresponding rotations are noted in FIG. 7 by arrows 460 and 461.

In operation, the operator of the push-pull table saw 300 adjusts the height adjustment-push pull mechanism 329 in order to achieve the desired height for the blade 320. The operator then rotates the knob 334 in order to rotate the keyed shaft 337. Rotation of the keyed shaft 337 rotates the inner portion 425 of the bearing assembly 410. Rotation of the inner portion 425 causes rotation of the gears 454 which rotate gears 456 of the side wall 422. The rotation of the side wall 422 causes rotation of the carrier 420 with respect to the carriage 400 thereby causing the beveling of the saw assembly (not shown) which causes beveling of the saw blade 320 with respect to the table top 304.

Once the correct height and bevel angle of the blade 320 are achieved, the operator pushes and pulls the height adjustment-push pull mechanism 329 in order to slide the carriage 400, the carrier 420 and therefore the saw assembly (not shown) and the blade 320 back and forth in order to make the desired cut of the workpiece. The bearing members 450 and 452 rotate on the keyed shaft 337 as the carriage 400 is pushed and pulled in response to the movement of the height adjustment-push pull mechanism 329.

While the geared interface between the gears 454 and 456 is depicted in FIG. 7 to have substantially similar profiles, the gears may be defined by different pitches and diameters resulting in the inner portion 425 to rotate at a different relative rotational speed than the gears 456. Also, intermediate gears may be used between the gears 454 and 456 to further change rate of rotation of the carriage 420 as compared to rate of rotation of the knob 334.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A push-pull power tool comprising:
a table;
a carriage configured to move along the table in a linear direction;
a cutting assembly carried by the carriage; and
a bevel adjustment arrangement configured to pivot the cutting assembly relative to the table, the bevel adjustment arrangement including an actuator,
wherein the actuator is configured to remain substantially stationary in the linear direction when the carriage is moved a substantial distance in the linear direction.

2. The push-pull power tool of claim 1 wherein the cutting assembly is fixed to a pivotable mount carried by the carriage, and wherein the bevel adjustment arrangement is operable to pivot the mount relative to the carriage.

3. The push-pull power tool of claim 2 wherein the pivotable mount comprises a toothed arc configured to engage a bevel gear on a rotatable rod.

4. The push-pull power tool of claim 2 wherein the bevel gear comprises a plurality of splines on the rotatable rod.

5. The push-pull power tool of claim 1 wherein the bevel adjustment arrangement comprises a rotatable rod coupled to the actuator, wherein the carriage is configured to slide along the rotatable rod when the carriage moves in the linear direction.

6. The push-pull power tool of claim 1 wherein the actuator is a rotatable knob.

7. The push-pull power tool of claim 1 further comprising a push-pull rod coupled to the carriage, wherein movement of the push-pull rod in the linear direction results in movement of the carriage in the linear direction.

8. The push-pull power tool of claim 1 wherein the carriage moves in the linear direction along a track supported by the table.

9. A push-pull table saw comprising
a housing;
a moveable carriage disposed within the housing, the moveable carriage configured to support a saw assembly having a blade, the moveable carriage configured to move with respect to fixed members coupled to the housing;
a push-pull rod coupled to the moveable carriage and configured to move the moveable carriage parallel to a first axis along the housing in response to movement of the push-pull rod;
a bevel control member coupled to the moveable carriage and configured to rotate the saw assembly along an arcuate path defining a plane in response to rotation of the bevel control member, wherein the plane is substantially perpendicular to the first axis,
wherein the bevel control member remains axially stationary during movement of the push-pull control rod and the moveable carriage parallel to the first axis; and
a height control member coupled to the saw assembly and configured to move the blade parallel to a second axis along the height of the housing in response to movement of the height control member,
wherein the bevel control member remains vertically stationary during movement of the blade parallel to the second axis.

10. The push-pull table saw of claim 9, further comprising:
a pivotable mount coupled to the moveable carriage, the saw assembly supported by the pivotable mount.

11. The push-pull table saw of claim 10, further comprising:
a toothed arc configured to engage a bevel gear on a rotatable rod.

12. The push-pull power tool of claim 12 wherein the bevel gear comprises a plurality of splines on the rotatable rod.

13. The push-pull table saw of claim 9 wherein the bevel control member coupled to a rotatable rod, wherein the moveable carriage is configured to slide along the rotatable rod when the moveable carriage moves parallel to the first axis.

14. The push-pull table saw of claim 9 wherein the actuator is a rotatable knob.

15. A push-pull saw comprising:
a carriage configured to movably support a saw assembly;
a push-pull rod coupled to the carriage and operable to move the carriage in a linear path of movement in response to the push-pull rod being moved in the linear path; and
a bevel control rod coupled to the carriage and operable to move the saw assembly in a bevel path defined within a plane substantially perpendicular to the linear path in response to rotation of the bevel control rod,
wherein the bevel control rod remains axially stationary during movement of the push-pull rod and the carriage in the linear path.

16. The push-pull saw of claim 15, further comprising:
a pivotable mount coupled to the carriage, the saw assembly supported by the pivotable mount.

17. The push-pull saw of claim 16, further comprising:
a toothed arc configured to engage a bevel gear on a rotatable rod.

18. The push-pull saw of claim 18 wherein the bevel gear comprises a plurality of splines on the rotatable rod.

19. The push-pull table saw of claim 15 wherein the bevel control member coupled to a rotatable rod, wherein the carriage is configured to slide along the rotatable rod when the carriage moves parallel to the linear path.

20. The push-pull table saw of claim 15, further comprising:
a height control member coupled to the saw assembly and configured to move a blade coupled to the saw assembly parallel the bevel path along the height of the housing in response to movement of the height control member, wherein the bevel control member remains vertically stationary during movement of the blade parallel to the vertical bevel path.
